(19) United States
(12) Patent Application Publication
(10) Pub. No.: US 2026/0247263 A1
(43) Pub. Date: Aug. 20, 2026

(54) CARBON-INTELLIGENT ACCESS CONTROL

(71) Applicant: MEDIATEK INC., Hsin-Chu (TW)

(72) Inventors: Chien-Sheng Yang, Hsinchu City (TW); Yuan-Chieh Lin, Hsinchu City (TW); Chia-Lin Lai, Hsinchu City (TW); Yu-Hsin Lin, Hsinchu City (TW); I-Kang Fu, Hsinchu City (TW)

(73) Assignee: MEDIATEK INC., Hsin-Chu (TW)

(21) Appl. No.: 19/469,386

(22) PCT Filed: Apr. 30, 2024
(86) PCT No.: PCT/CN24/90970

§ 371 Date: Sep. 26, 2025

Related U.S. Application Data
(60) Provisional application No. 63/501,687, filed on May 12, 2023.

(51) Int. Cl. H04W 48/08

(52) U.S. Cl. CPC H04W 48/08

(57) ABSTRACT

A method of access control for user equipment (UE) includes providing a plurality of access identities and/or access categories, determining an Eco-Rating of the UE, determining an access identity and/or access category of the plurality of access identities and/or access categories for the UE according to at least the Eco-Rating, and configuring the UE with the determined access identity and/or access category. This method seeks a balance between ensuring reliable network performance through optimal signal quality and promoting eco-friendly practices, making it a viable solution for network operators seeking to minimize their environmental impact while maintaining high-quality service.

### CROSS REFERENCE TO RELATED APPLICATION

This application claims the benefit of U.S. Provisional Application No. 63/501,687, filed on May 12th, 2023. The content of the application is incorporated herein by reference.

### TECHNICAL FIELD

The present invention is related to wireless communication, and more particularly to access control in wireless communication.

### BACKGROUND

Energy (e.g., electricity) may be tagged with carbon intensity depending on where, when, and how the given energy is produced and consumed. Carbon intensity is a critical metric for assessing the environmental impact of various activities. As in most case, for example solar power can have lower carbon intensity, and fossil fuel can have higher carbon intensity. As environmental awareness increases, the issue of how to design, develop, deploy, and operate “green” wireless networks becomes increasingly important.

Electricity generation is from energy sources (e.g., gas, coal, wind) with different levels of carbon emissions. In particular, due to the highly variable and unpredictable nature of renewable energy sources (e.g., solar energy), carbon intensity (i.e., average carbon emissions per unit of energy consumption) of electricity grid varies considerably by time and location. Thus, to guarantee the reduction of carbon emissions in computing and/or communication networks, there is a critical need to design a signaling framework or scheduling policy for networks, which accounts for temporal and spatial dimensions of energy sources.

The Information/Communications Technology (ICT) industry is one of the biggest consumers of electricity. The ICT industry estimated share of worldwide electricity consumption presently stands at 2-3%, and it is predicted to increase to 8-21% by 2030. Therefore, it is critical that the ICT industry considers not only reducing its electricity consumption, but also transitioning to cleaner sources of energy. However, quantifying, and subsequently reducing, the consumption of energy is not an easy task.

For example, there are many contributors for a web-based mobile application: 1) electricity usage of the mobile device running the application; 2) the infrastructure that carries the application message over the radio link to a cell tower; 3) the cell tower shared by more than one carrier and the fiber connecting the tower to the Internet backbone networks, owned by various Internet service providers; 4) the data center that runs the application logic in a cloud platform shared by different businesses. Thus, it is necessary to measure the aggregated environmental impact of each of these components.

In software industry, information of green factor has been made available. For example, the Carbon Aware SDK helps developers to build software that is mindful of its environmental impact, specifically its carbon footprint. The Carbon Aware SDK empowers developers to create “carbon-aware” applications. These applications can adapt their behavior based on the carbon intensity of the electricity grid. They can perform more intensive tasks when the grid is powered by cleaner sources like wind or solar, and throttle down during periods of higher emissions. They also optimize resource utilization by choosing to run in locations with lower carbon footprints, potentially by leveraging cloud computing resources in regions with cleaner energy sources. The SDK provides functionalities such as measuring carbon emissions, data collection and reporting. The Carbon Aware SDK can potentially reduce the environmental impact of software by making software more energy-efficient, developers can contribute to lowering the overall carbon footprint of the technology sector.

In wireless communication, standards developed by the International Telecommunication Union (ITU) have provided models for the industry to follow. However, knowing only the energy consumption is not sufficient. It is also necessary to derive a measure of carbon intensity for the energy consumption in order to determine the carbon footprint of the wireless network components, including hardware and software, when they are pressed into service.

### SUMMARY

An embodiment provides a method of access control for user equipment (UE). The method comprises providing a plurality of access identities and/or access categories, determining an Eco-Rating of the UE, determining an access identity and/or access category of the plurality of access identities and/or access categories for the UE according to at least the Eco-Rating, and configuring the UE with the determined access identity and/or access category.

Another embodiment provides a method of access control for user equipment (UE). The method comprises determining an Eco-Rating of the UE, determining a BarringFactor and/or a BarringTime for the UE according to at least the Eco-Rating, and configuring the UE with the BarringFactor and/or the BarringTime.

An embodiment provides a user equipment (UE) comprising a memory and a processor coupled to the memory. The memory is for storing a list of plurality of access identities and/or access categories.

The processor is used to determine an Eco-Rating of the UE, determine an access identity and/or access category of the plurality of access identities and/or access categories for the UE according to at least the Eco-Rating, and configure the UE with the determined access identity and/or access category.

Another embodiment provides a user equipment (UE) comprising a memory and a processor coupled to the memory. The processor is used to determine an Eco-Rating of the UE, determine a BarringFactor and/or a BarringTime for the UE according to at least the Eco-Rating, and configure the UE with the BarringFactor and/or the BarringTime.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an exemplary scenario of a communication system in accordance with implementations of the present disclosure.

FIG. 2 illustrates block diagrams of UE and network entity in accordance with the embodiments of the present disclosure.

FIG. 3, FIG. 4 and FIG. 5 illustrate embodiments of carbon-intelligent network selection incorporated with Eco-Rating.

FIG. 6, FIG. 7 and FIG. 8 illustrate embodiments of carbon-intelligent network reselection incorporated with Eco-Rating.

FIG. 9 illustrates an embodiment of carbon-intelligent cell selection incorporated with Eco-Rating.

FIG. 10 illustrates another embodiment of carbon-intelligent cell selection incorporated with Eco-Rating.

FIG. 11 illustrates an embodiment of carbon-intelligent QoS mechanism incorporated with Eco-Rating.

FIG. 12 illustrates another embodiment of carbon-intelligent QoS mechanism incorporated with Eco-Rating.

### DESCRIPTION OF EMBODIMENTS

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. It should be understood that the disclosure is described primarily in the context a 3GPP specified wireless network (e.g., 4G and 5G), but it can be implemented in other forms of cellular or non-cellular wireless networks as well.

### Introduction & Definition

In particular, the following technique, apparatus and system can be applied to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access (UTRA) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi), IEEE 802.16 (WiMAX), IEEE 802.20, or Evolved UTRA (E-UTRA). UTRA is part of the Universal Mobile Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

For convenience of description, the implementation of the present specification is mainly described in relation to a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other wireless communication systems.

As described by the 3GPP, different wireless communication systems standards and protocols can use various radio access networks (RANs) for communicating between a base station of the RAN (which may sometimes be referred to generally as a RAN node, a network node, or simply a node) and a wireless communication device known as user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN). The RAN can include base stations (cell sites), radio equipment controllers (RECs) and fronthaul and backhaul networks to transport data between base stations, RECs, and the core network.

The RAN can include one or more access nodes, which may be referred to as base station, NodeB, evolved NodeB (eNB), next Generation NodeB (gNB), 6G nodes, RAN nodes, controllers, transmission reception points (TRPs), and so forth, and can include ground stations (e.g., terrestrial access points) or satellite stations providing signal coverage within a geographic area (e.g., a cell). The RAN may include one or more RAN nodes for providing macrocells, picocells, femtocells, or other types of cells. A macrocell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having an association with the femtocell (e.g., UEs in a Closed Subscriber Group (CSG), UEs for users in the home, etc.).

A base station used by a RAN may correspond to that RAN. An example of an E-UTRAN base station is an Evolved Universal Terrestrial Radio Access Network (E-UTRAN) Node B (also referred to as evolved Node B, enhanced Node B, eNodeB, or eNB). Another example of an NG-RAN base station is a next generation Node B (also referred to as a gNodeB or gNB).

A RAN provides its communication services with external entities through its connection to a core network (CN). For example, E-UTRAN may utilize an Evolved Packet Core.

Each RAN may use one or more radio access technologies (RATs) to perform communication between the base station and the UE. For example, the GERAN implements GSM and/or EDGE RAT, the UTRAN implements UMTS RAT or other 3GPP RAT, the E-UTRAN implements LTE RAT (sometimes referred to as LTE), and NG-RAN implements NR RAT (sometimes referred to as 5G RAT, 5G NR RAT, or NR). In certain deployments, the E-UTRAN may also implement NR RAT. In certain deployments, NG-RAN may also implement LTE RAT.

For terms and techniques not specifically described, reference may be made to wireless communication standard documents (e.g., 3GPP Specifications) issued before this specification.

Furthermore, in this specification the term “Eco-Rating” is used to describe carbon intensity or other terms of measuring energy “greenness”. Eco-Rating accommodates both total amount and rate (i.e., a measure, relative to another measure) regarding environment impact according to the context.

In more detail, Eco-Rating can be defined as a factor calculated with environmental impact, for example, carbon efficiency, carbon emission, and/or carbon footprint related to energy consumption. With the concept of rate, Eco-Rating can be further defined as per service, per network slice, per subscriber, per user equipment (UE), per unit (e.g., byte) of data transmit/receive, per network element (e.g., per wireless base station), per core network element, per application server . . . etc.

In other words, high Eco-Rating can mean “more green” or “greener”, which can be equivalent to less environmental impact and higher sustainability, for example, lower carbon intensity, lower carbon efficiency, lower carbon emission, and lower carbon footprint. In contrast, low Eco-Rating can mean “less green”, which can be equivalent to more environmental impact and lower sustainability, for example, higher carbon intensity, higher carbon efficiency, higher carbon emission, and higher carbon footprint.

In addition, “Eco-Rating” can represent energy efficiency. High energy efficiency can mean “more green” or “greener”, which can be equivalent to less environmental impact. In contrast, low energy efficiency can mean “less green”, which can be equivalent to more environmental impact.

In addition, “Eco-Rating” can represent energy consumption. High energy consumption can mean “more green” or “greener”, which can be equivalent to less environmental impact. In contrast, low energy consumption can mean “less green”, which can be equivalent to more environmental impact.

Furthermore, “Eco-Rating” can represent green factor. High green factor can mean “more green” or “greener”, which can be equivalent to less environmental impact. In contrast, low green factor can mean “less green”, which can be equivalent to environmental impact.

The term “carbon-intelligent” or “carbon-aware” approach can mean an approach that is intended to bring less environmental impact, i.e., high Eco-Rating. This can usually be achieved by, for example, implementing more renewable and/or clean energy.

In this specification, the term “network” can include but not limited public land mobile network (PLMN), Stand-alone Non-Public Network (SNPN) and Public Network Integrated Non-public Network (PNI-NPN). Eco-Rating information of a candidate network, or Eco-Rating threshold (or target) can be obtained from UE configuration, upper layer, user input, broadcasted information, and/or signaling (NAS, RRC or L2/L1) message from a serving network or a home network.

The UE configuration/parameters can be (pre-) configured or (pre-) stored in a UMTS Subscriber Identity Module (USIM) or non-volatile random-access memory (NVRAM). Optionally, the UE configuration can be updated by the network and/or controlled by the home network.

In this specification, the Eco-Rating information can be defined as per frequency, per group of frequencies, per cell, per group of cells, per access technology, per slice or service type, per traffic type or QoS flow, per traffic descriptor or route selection descriptor, and/or per group ID.

In addition, the Eco-Rating information can be associated with time information, including time validity information to indicate when the Eco-Rating information is valid, and/or location information, including location validity information to indicate where the Eco-Rating information is valid. In other words, the Eco-Rating information can be valid only during a specific time interval and/or within a specific location area.

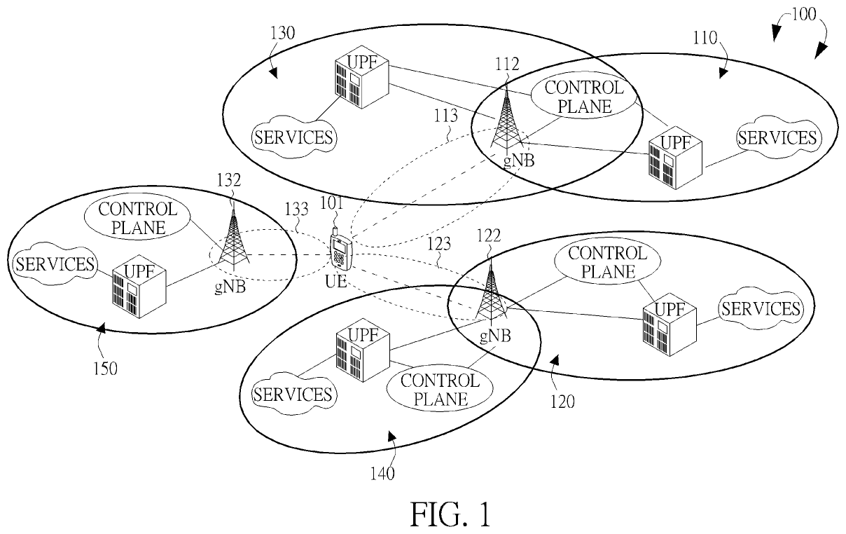

FIG. 1 illustrates an exemplary scenario of a communication system 100 in accordance with implementations of the present disclosure. The communication system 100 includes networks 110, 120, 130, 140 and 150. Each of the networks 110, 120, 130, 140 and 150 may be a Public Land Mobile Network (PLMN), a Stand-alone Non-public Network (SNPN), or a Public Network Integrated Non-public Network (PNI-NPN). The PLMN may a home PLMN (HPLMN), visited PLMN (VPLMN) or other types of PLMN.

The network 110 may include control plane, user plane functionality (UPF), and applications that provide various services by communicating with user equipment (UE), such as UE 101. A radio access network (RAN) 113 provides radio access for UE 101 via a radio access technology (RAT). A base station gNB 112 belongs to the RAN 113. The control plane includes various functionalities, e.g., Access and Mobility Management Function (AMF), Session Management Function (SMF), Authentication Server Function (AUSF), Unified Data Management (UDM) and Policy Control Function (PCF). These network functions collaborate to provide connectivity, mobility management, security, and data handling in the core network. The network 120 may include control plane, user plane functionality (UPF), and applications that provide various services by communicating with user equipment (UE), such as the UE 101. A base station gNB 112 belongs to a RAN 123. The RAN 123 provides radio access for UE 101 via a RAT. The control plane includes various functionalities, e.g., AMF, SMF, AUSF, UDM, and PCF. The control plane in the network 110 communicates with gNB 112. Similarly, the network 130 may include control plane, user plane functionality (UPF), and applications that provide various services by communicating with user equipment (UE), such as UE 101. The base station gNB 112 belongs to the RAN 113. The RAN 113 provides radio access for UE 101 via a RAT. The control plane includes various functionalities, e.g., AMF, SMF, AUSF, UDM, and PCF. The control plane in the network 110 communicates with gNB 112. In addition, the UE 101 may be equipped with one or more radio frequency (RF) transceivers.

In like manner, the networks 140 and 150 have substantially the same architectures as the network 110, 120 or 130. Thus, the description is not repeated herein.

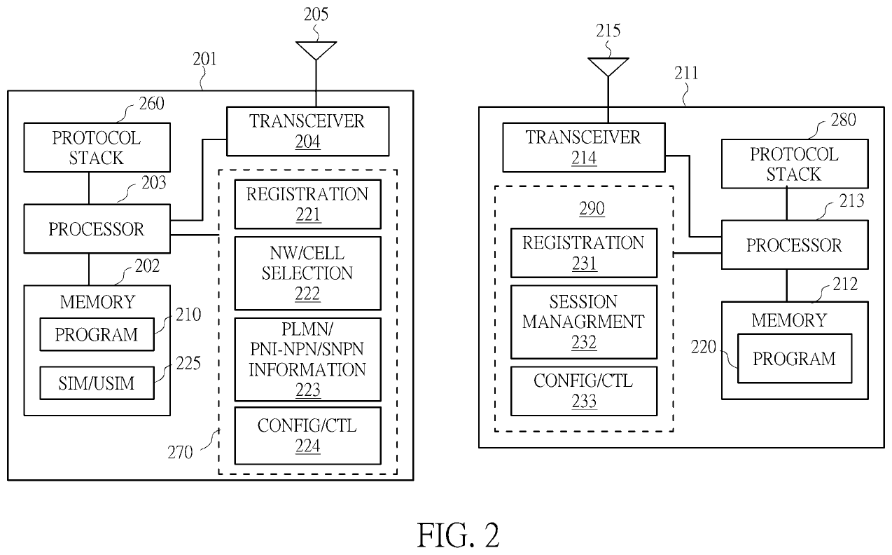

FIG. 2 illustrates block diagrams of UE 201 and a network entity 211 in accordance with the embodiments of the present disclosure. The UE 201 may be an implementation of the UE 101. The network entity 211 may be a base station (e.g., gNB 112) combined with an AMF. The network entity 211 includes an antenna 215, a radio frequency (RF) transceiver module 214, a processor 213, a memory 212, and control functional modules and circuits 290. The antenna 215 transmits and receives radio signals. The RF transceiver module 214, coupled with the antenna 215, receives RF signals from antenna 215, converts the RF signals to baseband signals and sends the baseband signals to the processor 213. The RF transceiver 214 receives baseband signals from the processor 213, converts the baseband signals to RF signals, and sends the baseband signals to the antenna 215. The processor 213 processes the received the baseband signals and invokes different functional modules to perform features in the network entity 211. The memory 212 stores program instructions and data 220 to control the operations of the network entity 211. The control functional modules and circuits 290 includes a registration circuit 231 for handling registration and mobility procedure, a session management circuit 232 for handling session management functionalities, and a configuration and control circuit (CONFIG/CTL) 233 for adjusting different parameters to configure and control user equipment (e.g., UE 201).

Similarly, the UE 201 includes a memory 202, a processor 203, and a radio frequency (RF) transceiver module 204 coupled to an antenna 205. The RF transceiver 204 receives RF signals from the antenna 205, converts the RF signals to baseband signals, and sends the baseband signals to the processor 203. The RF transceiver 204 also converts received baseband signals from the processor 203, converts the baseband signals to RF signals, and sends the RF signals to the antenna 205. The processor 203 processes the received baseband signals and invokes different functional modules and circuits to perform features in the UE 201. The memory 202 stores data and program instructions 210 to be executed by the processor 203 to control the operations of the UE 201.

The UE 201 also comprises a set of functional modules and control circuits to carry out functional tasks of the UE 201. A protocol stack 260 include Non-Access-Stratum (NAS) layer to communicate with an AMF entity coupled to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions in the memory 202, interwork with each other to allow the UE 201 to perform embodiments and functional tasks and features in the network. In an example, the system modules and circuits 270 includes a registration circuit 221 for performing registration and mobility procedure with the network, a network and cell selection circuit 222 for performing network and cell selection, a PLMN/PNI-NPN/SNPN information maintenance circuit 223 for processing adding, removing, and resetting of PLMN/PNI-NPN/SNPN information in SIM/USIM 225 and/or in the memory 202 (where the source of the information may be also from signaling), and a configuration and control circuit 224 for handling configuration and control parameters. It should be noted that the network selection and registration related information, such as HPLMN, Operator Controlled PLMN/SNPN Selector list, User Controlled PLMN/SNPN Selector list, may be stored in SIM/USIM 225 and/or in the memory 202.

### Carbon-Intelligent Network Selection and Reselection

Network (e.g., PLMN) selection refers to the process by which UE, like a phone or tablet, chooses a specific cellular network to connect to. This network is identified by a Public Land Mobile Network (PLMN) identifier. It is crucial for the UE select a network based on a set of rules and priorities. The selection can be based on predefined priority and other factors such as signal strength, roaming agreements and user preferences.

As described in the present 3GPP technical specification, an exemplary priority order of the networks (e.g., networks 110, 120, 130, 140 and 150) can be the automatic mode candidate priority order. That is, mobile station (MS) or user equipment (UE) selects and attempts registration on a PLMN/access technology combinations in the following order: 1) either the HPLMN (if the EHPLMN list is not present or is empty) or the highest priority EHPLMN that is available (if the EHPLMN list is present); 2) each PLMN/access technology combination in the “User Controlled PLMN Selector with Access Technology” data file in the SIM (in priority order); 3) each PLMN/access technology combination in the “Operator Controlled PLMN Selector with Access Technology” data file in the SIM (in priority order); 4) other PLMN/access technology combinations with received high quality signal in random order; 5) other PLMN/access technology combinations in order of decreasing signal quality.

In other words, the UE searches for available PLMNs and checks if they match the prioritized list on the USIM. Only available and allowable PLMNs from the priority list are considered for selection. The highest priority PLMN/access technology combination (from SIM card) that is available and allowable is selected. Then, if no combination from the highest priority list is available, the UE moves down the list and checks for the next available and allowable combination. This process continues until a suitable PLMN is found, or no further options remain.

In another example of automatic network selection, the UE selects and attempts registration on available and allowable SNPNs in the
following order: 1) the SNPN the UE was last registered with (if available); 2) the subscribed SNPN, which is identified by the PLMN ID and Network identifier (NID) for which the UE has Subscription Permanent Identifier (SUPI) and credentials; 3) If the UEs supports access to an SNPN using credentials from a Credentials Holder (CH) then the UE continues by selecting and attempting registration on available and allowable SNPNs which broadcast the indication that access using credentials from a Credentials Holder is supported in the following order: i) SNPNs in the user controlled prioritized list of preferred SNPNs (in priority order); ii) SNPNs in the Credentials Holder controlled prioritized list of preferred SNPNs (in priority order); iii) SNPNs, which additionally broadcast a Group IDs for Network Selection (GIN) contained in the Credentials Holder controlled prioritized list of preferred GINs (in priority order); 4) SNPNs, which additionally broadcast an indication that the SNPN allows registration attempts from UEs that are not explicitly configured to select the SNPN, i.e. the broadcasted NID or GIN is not present in the Credentials Holder controlled prioritized lists of preferred SNPNs/GINs in the UE.

In other words, the UE searches for available SNPNs and checks if they match the prioritized list. Only available and allowable SNPNs from the priority list are considered for selection. The highest priority SNPN that is available and allowable is selected. Then, if no SNPN from the highest priority list is available, the UE moves down the list and checks for the next available and allowable SNPN. This process continues until a suitable SNPN is found, or no further options remain.

It should be noted that the combination of a PLMN ID and Network identifier (NID) identifies an SNPN. The NID supports two assignment models. Under self-assignment model, NIDs are chosen individually by SNPNs at deployment time (and may therefore not be unique) but use a different numbering space than the coordinated assignment NIDs. Under coordinated assignment model, NIDs are assigned using one of the following two options: 1) The NID is assigned such that it is globally unique independent of the PLMN ID used; or 2) The NID is assigned such that the combination of the NID and the PLMN ID is globally unique. The Group IDs for Network Selection (GIN) supports two assignment models. Under self-assignment model, GINs are chosen individually and may therefore not be unique. Under coordinated assignment model, GIN uses a combination of PLMN ID and NID and is assigned using one of the following two options: 1) The GIN is assigned such that the NID is globally unique (e.g., using IANA Private Enterprise Numbers) independent of the PLMN ID used; or 2) The GIN is assigned such that the combination of the NID and the PLMN ID is globally unique.

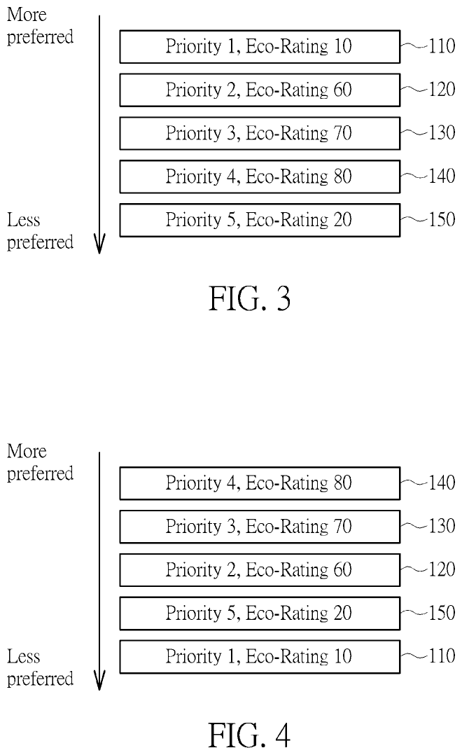

Building on the existing cell selection and reselection procedures, the disclosure introduces carbon-intelligent network selection. FIGS. 3, 4 and 5 illustrate embodiments of carbon-intelligent network selection incorporated with Eco-Rating. In this illustration, the network 110 has priority 1 (i.e., the highest priority); the network 120 has priority 2; the network 130 has priority 3; the network 140 has priority 4; the network 150 has priority 5 (i.e., the lowest priority), according to the automatic mode candidate priority order specified by 3GPP. Additionally, each network is also tagged with Eco-Rating. For example, the network 110 has Eco-Rating 10; the network 120 has Eco-Rating 60; the network 130 has Eco-Rating 70; the network 140 has Eco-Rating 80; the network 150 has Eco-Rating 20.

By incorporating the concept of renewable energy, the networks (i.e., networks 110, 120, 130, 140 and 150) may have the same or different Eco-Ratings. For example, some networks use more renewable (green) energy and some others use more non-renewable (i.e., gray energy, on-grid power) energy. Renewable energy can be optional to each network because its supply is highly variable and unpredictable. In contrast, non-renewable energy (i.e., gray energy, on-grid power) is stable, but it produces more carbon emission. In an example, a network can use 100% renewable energy, 90% renewable energy, 80% renewable energy, or even 0% renewable energy. In another example, a network can use 90% renewable energy at 9 AM and only 10% renewable energy at 3 PM.

In the embodiment of FIG. 3, when Eco-Rating is not taken into consideration in network selection by the UE 101, the UE 101 would have preference to the networks 110, 120, 130, 140 and 150 according to their original priority. In other words, the network 110 is the most preferred network and the network 150 is the least preferred network.

In the embodiment of FIG. 4, when Eco-Rating is taken into consideration in network selection by the UE 101, the UE 101 can have preference to the networks 110, 120, 130, 140 and 150 according to their Eco-Rating. Thus, the network 140, having Eco-Rating 80 (i.e., the highest Eco-Rating), would be the most preferred network, and the network 110, having Eco-Rating 10 (i.e., the lowest Eco-Rating), would be the least preferred network. Specifically, the UE 101 can prefer or prioritize a higher Eco-Rating network over a lower Eco-Rating network. This method of network selection is considered carbon-intelligent because it can optimize carbon emission or footprint to a certain degree.

In the embodiment of FIG. 5, the networks 110, 120, 130, 140 and 150 are divided into two groups according to the Eco-Rating threshold (e.g., 50). For example, the UE 101 can select a network if the Eco-Rating of the network is greater than (or equal to) the Eco-Rating threshold. If there is more than one network having the Eco-Rating greater than (or equal to) the Eco-Rating threshold, the UE 101 can select a network with the highest priority from the network having Eco-Rating surpassing the threshold. If no network fulfills the Eco-Rating threshold, the UE 101 may repeat the network selection procedure without considering Eco-Rating threshold. In this case, the UE 101 would select the network with highest original priority.

In other words, the UE (e.g., UE 101) prefers or prioritizes a network with Eco-Rating greater than (or equal to) the Eco-Rating threshold over a network with Eco-Rating less than the Eco-Rating threshold. Among the networks with Eco-Rating greater than (or equal to) the Eco-Rating threshold, these networks (e.g., networks 120, 130 and 140) are further prioritized according to original priority order. Among the networks with Eco-Rating less than the Eco-Rating threshold, these networks (e.g., networks 110 and 150) are also prioritized according to original priority order.

It should be noted that in the above described embodiments, the UE (e.g., UE 101) can prefer or prioritize of a network when: 1) the UE is in automatic network selection mode; 2) the UE supports the “carbon-aware network selection”; 3) the UE is configured for using “carbon-aware network selection” in a mobile equipment (ME); and/or 4) the “carbon-aware network selection” is configured in the USIM.

In the case of manual network selection, if a user triggers the manual network selection mode, the UE 101 would indicate to the user any available networks and would also indicate to the user the Eco-Rating of each available network, and/or whether the Eco-Rating of an available network is higher than, equal to, or lower than an Eco-Rating threshold.

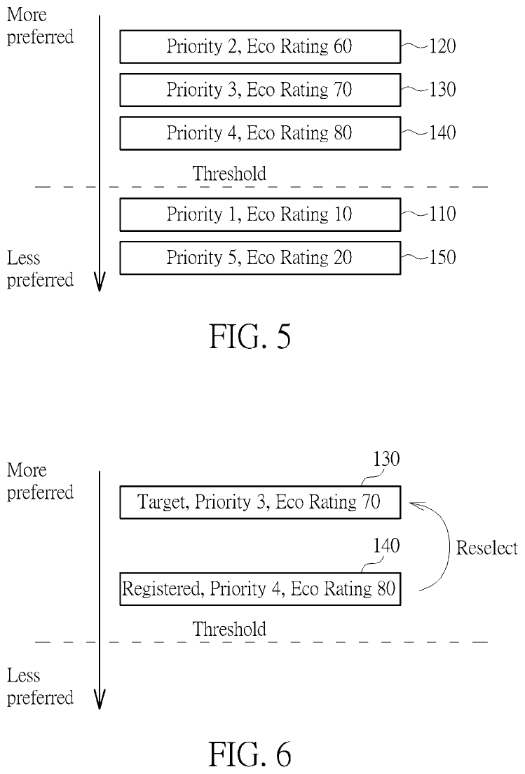

FIGS. 6, 7 and 8 illustrate embodiments of carbon-intelligent network reselection incorporated with Eco-Rating. The UE 101 can maintain, receive and/or preconfigure a list of networks and store them in its memory. When the UE 101 reselects a network from one or more networks (e.g., networks 110, 120, 130, 140 and 150), the UE 101 may take Eco-Rating into consideration during the reselection process. The UE 101 may perform the network selection procedure periodically, and the network selection procedure may consider all available networks.

In the embodiment of FIG. 6, the UE 101 is originally registered to the network 140. During the periodic network selection process, the UE 101 can reselect a target network (i.e., network 130) of a higher priority according to original priority order. In particular, the Eco-Rating of both the target network and the originally registered network are greater than (or equal to) the Eco-Rating threshold (e.g., 50). In other words, the UE 101 reselects a higher priority (according to original priority order) network if the Eco-Rating of target network is greater than (or equal to) the Eco-Rating threshold.

In the embodiment of FIG. 7, the UE 101 is originally registered to the network 150. During the periodic network selection process, the UE 101 can reselect a target network (i.e., network 140) of a higher priority according to original priority order. In particular, the Eco-Rating of the target network is greater than (or equal to) the Eco-Rating threshold (e.g., 50), but the Eco-Rating of the originally registered network is less than the Eco-Rating threshold. In other words, the UE 101 reselects a higher priority (according to original priority order) network only if the Eco-Rating of target network is greater than (or equal to) the Eco-Rating threshold and the Eco-Rating of the originally registered network is less than the Eco-Rating threshold.

In the embodiment of FIG. 8, the UE 101 is originally registered to the network 150. During the periodic network selection process, the UE 101 can reselect a target network (i.e., network 110) of a higher priority according to original priority order. In particular, the Eco-Rating of both the target network and the originally registered network are less than the Eco-Rating threshold (e.g., 50). In other words, if no network, including the registered network, fulfills the Eco-Rating threshold, the UE 101 can perform the normal periodic network selection for higher priority networks, i.e., only considering the original priority without Eco-Rating.

With the proposed method of carbon-intelligent network selection and reselection, carbon emission or footprint can be optimized and, as a result, contribute to a more sustainable planet in environmental aspect and potentially reduce carbon tax in the financial aspect.

### Carbon-Intelligent Cell Selection and Reselection

A cell is a geographical area covered by a signal from a single base station. Cell selection is performed by one of the following two procedures: a) Initial cell selection (no prior knowledge of which RF channels are NR frequencies); or b) Cell selection by leveraging stored information, which requires stored information of frequencies and optionally also information on cell parameters from previously received measurement control information elements or from previously detected cells. The initial cell selection includes the following steps: 1) The UE scans all RF channels in the NR bands according to its capabilities to find a suitable cell; 2) On each frequency, the UE need only search for the strongest cell, except for operation with shared spectrum channel access where the UE may search for the next strongest cell or cells; 3) Once a suitable cell is found, this cell should be selected.

The cell selection criterion S, defined in the 3GPP specifications for both 4G and 5G, focuses primarily on the signal strength and quality. It essentially determines whether User Equipment (UE) should initiate the registration process with a particular cell based on these parameters. Under current 3GPP specification (TS 38.304), the cell selection criterion S is fulfilled when:

$$Srxlev > 0 \&\& Squal > 0$$

$$where :$$

$$Srxlev = {Q}_{rxlevmeas} - ( {Q}_{rxlevmin} + {Q}_{rxlevminoffset} ) - {P}_{compensation} - {Qoffset}_{temp}$$

$$Squal = {Q}_{qualmeas} - ( {Q}_{qualmin} + {Q}_{qualminoffset} ) - Qoffset\_temp$$

The descriptions of the above parameters are listed in Table 1 below.

TABLE 1

| | |
|---|---|
| Srxlev: | Cell selection RX level value (dB). |
| Squal: | Cell quality value (dB). |
| Qᵣₓₗₑᵥₘₑₐₛ: | Measured cell RX level value (RSRP). |
| Qᵣₓₗₑᵥₘᵢₙ: | Minimum required RX level in the cell. |
| Q_{rxlevminoffset}: | Offset to the signaled Qᵣₓₗₑᵥₘᵢₙ taken into account in a Srxlev evaluation as a |
| | result of a periodic search for a higher priority PLMN while camped normally in |
| | a VPLMN. |
| P_{compensation}: | For FR1, if the UE supports the additionalPmax in the NR-NSPmaxList, if |
| | present, in SIB1, SIB2 and SIB4: |
| | max(P_{EMAX1} − P_{PowerClass}, 0) − (min(P_{EMAX2}, P_{PowerClass}) − min(P_{EMAX1}, P_{PowerClass})) (dB); |
| | else: |
| | max(P_{EMAX1} − P_{PowerClass}, 0) (dB). |
| | For FR2, P_{compensation} is set to 0 (dB). |
| Qoffsetₜₑₘₚ: | Offset temporarily applied to the cell. |
| Q_{qualmeas}: | Measured cell quality value (RSRQ). |
| Q_{qualmin}: | Minimum required quality level in the cell. |
| Q_{qualminoffset}: | Offset to the signaled Q_{qualmin} taken into account in a Squal evaluation as a result |
| | of a periodic search for a higher priority PLMN while camped normally in the |
| | VPLMN. |
| P_{EMAX1}, P_{EMAX2}: | Maximum TX power level of UE may use when transmitting on the uplink in the |
| | cell (dBm) defined as P_{EMAX} in TS 38.101. |
| P_{PowerClass}: | Maximum RF output power of the UE (dBm) according to the UE power class as |
| | defined in TS 38.101-1. |

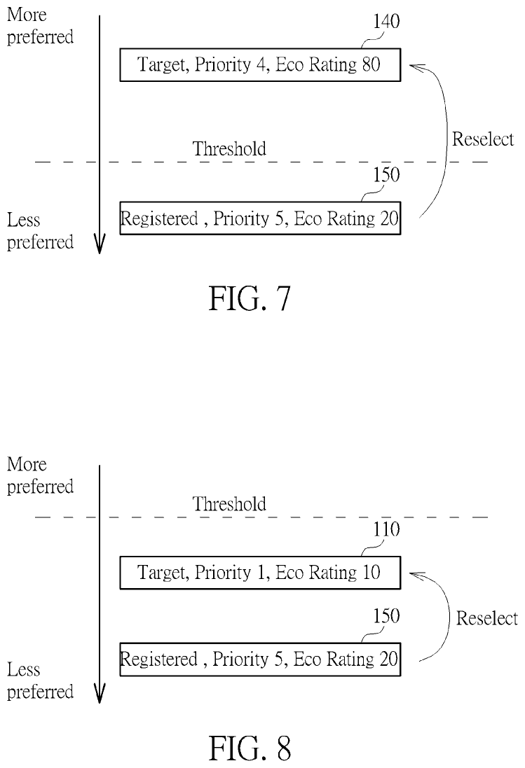

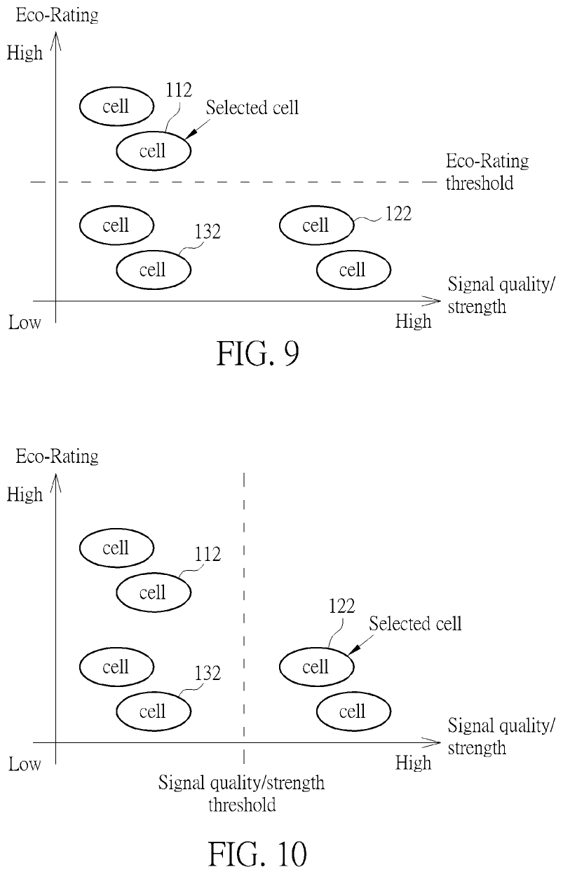

Building on the existing cell selection and reselection procedures, the disclosure introduces carbon-intelligent cell selection. FIG. 9 illustrates an embodiment of carbon-intelligent cell selection incorporated with Eco-Rating. The vertical axis represents Eco-Rating, and the horizontal axis represents signal quality and strength. A cell is a geographical area covered by a signal from a single base station (e.g., gNB 112, 122 or 132). When the UE 101 performs cell selection from cells of different frequencies, the UE 101 can take Eco-Rating into consideration during the process. Firstly, the UE 101 scans RF channels, frequencies, and/or bands according to its capabilities. On each frequency, the UE 101 can search and select a cell according to selection rules. In this embodiment, the UE 101 selects the strongest cell (in signal quality and strength) which satisfies the Eco-Rating threshold. For example, the cell covered by the gNB 112 is selected because this cell is the strongest cell (in signal quality and strength) which satisfies the Eco-Rating threshold.

By incorporating the concept of renewable energy, the cell associated to the base stations (i.e., gNB 112, 122 or 123) may have the same or different Eco-Ratings. For example, some cells (or base stations) use more renewable (green) energy and some others use more non-renewable (i.e., gray energy, on-grid power) energy. Renewable energy can be optional to each cell because its supply is highly variable and unpredictable. In contrast, non-renewable energy (i.e., gray energy, on-grid power) is stable, but it produces more carbon emission. In an example, a cell (or a base station) can use 100% renewable energy, 90% renewable energy, 80% renewable energy, or even 0% renewable energy. In another example, a cell (or a base station) can use 90% renewable energy at 9 AM and only 10% renewable energy at 3 PM.

FIG. 10 illustrates another embodiment of carbon-intelligent cell selection incorporated with Eco-Rating. The vertical axis represents Eco-Rating, and the horizontal axis represents signal quality and strength. A cell is a geographical area covered by a signal from a single base station (e.g., gNB 112, 122 or 132). When the UE 101 performs cell selection from cells of different frequencies, the UE 101 can take Eco-Rating into consideration during the process. Firstly, the UE 101 scans RF channels, frequencies, and/or bands according to its capabilities. On each RF channel, frequency, and/or band, the UE 101 can search and select a cell according to selection rules. In this embodiment, the UE 101 selects greenest cell (highest Eco-Rating) satisfying the basic signal criteria threshold, that is, the cell with highest Eco-Rating satisfying criteria S threshold, a signal quality (e.g., RSRQ, SNR) threshold, and/or strength (e.g., RSRP) threshold. For example, the cell covered by the gNB 122 is selected because this cell is the greenest cell (highest Eco-Rating) which satisfies the basic signal criteria threshold.

When camped on a cell, the UE (e.g., UE 101) should regularly search for a better cell according to the cell reselection criteria. The UE may determine the priority of a list of frequencies or cells during the cell reselection process. Absolute priorities of different NR frequencies or inter-RAT frequencies may be provided to the UE in the system information, in the RRCRelease message, or by inheriting from another RAT at inter-RAT cell reselection. In the case of system information, an NR frequency or inter-RAT frequency may be listed without providing a priority (i.e. the field cellReselectionPriority is absent for that frequency). In case UE receives RRCRelease with deprioritisationReq, UE should consider current frequency and stored frequencies due to the previously received RRCRelease with deprioritisationReq or all the frequencies of NR to be the lowest priority frequency (i.e. lower than any of the network configured values) while T325 (a timer defined in 3GPP TS 38.331) is running irrespective of camped RAT. The UE deletes the stored deprioritisation requests when a PLMN selection or SNPN selection is performed on request by NAS.

If the serving cell fulfills Srxlev>S_{IntraSearchP} and Squal>S_{IntraSearchQ}, the UE may not perform intra-frequency measurements; otherwise, the UE performs intra-frequency measurements. If the serving cell fulfills Srxlev>S_{nonIntraSearchP} and Squal>S_{nonIntraSearchQ}, UE may choose not to perform measurements of NR inter-frequency cells of equal or lower priority, or inter-RAT frequency cells of lower priority; otherwise, the UE performs measurements of NR inter-frequency cells of equal or lower priority, or inter-RAT frequency cells of lower priority.

It should be noted that S_{IntraSearchP} (Cell Selection RX Level Threshold) represents the minimum acceptable RSRP, measured in dBm, for the serving cell. S_{IntraSearchQ} (Cell Selection Quality Threshold) represents the minimum acceptable signal quality, measured in dB, for the serving cell.

When incorporating the concept of renewable energy, during the cell reselection process, the UE (e.g., UE 101) may determine a list of frequencies or cells to be lower in priority if that the list of frequencies or cells does not support Eco-Rating, has lower Eco-Rating, or the its Eco-Rating is below an Eco-Rating threshold. On the other hand, the UE (e.g., UE 101) may determine a list of frequencies or cells to be higher in priority if that the list of frequencies or cells supports Eco-Rating, has higher Eco-Rating, or the its Eco-Rating is above an Eco-Rating threshold. In addition, the cell selection criterion can be modified to Srxlev>0 and/or Squal>0.

In one illustration, the UE can maintain, receive and/or preconfigure a list of cells and store them in its memory. Within the list of cells, a first set of cells has information associated with Eco-Rating. The first set of cells is granted a first priority level. This allows user equipment (UE) to preferentially select and register with cells that have the Eco-Rating over cells that do not during cell reselection procedures.

In a further illustration, there can be a second set of cells including only those cells that have Eco-Rating greater than or equal to an Eco-Rating threshold. The second set of cells is granted a second priority level that is higher than the first priority level of the full first set. This allows the UE to most preferentially select and register with the cells having the highest Eco-Rating from among the first set during cell reselection.

The Eco-Rating and priority levels allow the network to influence cell reselection by the UE toward more environmentally-friendly or energy efficient cells when possible. This provides environmental benefits and energy savings.

Furthermore, the UE can determine the priority of a list of frequencies or cells based on a UE state, usage, energy type or subscription. The UE state may represent the battery level of the UE. For example, the UE may prefer a cell of weaker signal strength when the battery level of the UE is relatively high; the UE may prefer a cell of stronger signal strength when the battery level of the UE is relatively low.

In one illustration, the UE can maintain, receive and/or preconfigure a list of cells and store them in its memory. Within the list of cells, a first set of cell have information associated with Eco-Rating. The first set of cells having the Eco-Rating is granted a first priority level. This allows user equipment (UE) to preferentially select and register with cells that have the Eco-Rating over cells that do not during cell reselection procedures.

In a further illustration, there can be a second set of cells including only those cells that have Eco-Rating greater than or equal to an Eco-Rating threshold. The second set of cells is granted a second priority level that is higher than the first priority level of the full first set. This allows the UE to most preferentially select and register with the cells having the highest Eco-Rating from among the first set during cell reselection.

The Eco-Rating and priority levels allow the network to influence cell reselection by the UE toward more environmentally-friendly or energy efficient cells when possible. This provides environmental benefits and energy savings.

The usage may be a specific service (e.g., extended reality (XR), AI heavy computing), session (e.g., high speed session, high data rate session) and/or network slice, used by the UE. The UE can determine the priority of a list of frequencies or cells according to the above described usage.

A subscription may indicate that the subscriber subscribes to use carbon efficient service. As a result, the UE with such subscription may prefer a cell of higher Eco-Rating.

It should be noted that each cell typically operates on multiple frequencies or frequency channels within a specific frequency band in a network. Hence, the method for determining the priorities of cells may be applied to determine the priorities of a range of frequencies.

### Carbon-Intelligent Service-Aware Reselection

User equipment (e.g., UE 101) may sometimes use computational heavy services, applications, network sessions and/or a network slices (e.g., AI training or inference), which can be power demanding and produce more carbon emission. In the scenario which the UE performs a power demanding usage, the UE can select a more eco-friendly cell and/or network from available cells and/or networks to mitigate environmental impact (e.g., to reduce carbon emission). On the other hand, when the UE is not using computational demanding services, applications, network sessions and/or network slices, the UE may or may not need to select a more eco-friendly cell and/or network.

Therefore, when selecting a cell, a network and/or even a frequency from a range of available frequencies, the ongoing services, applications, network sessions and/or network slices used by the UE can be taken into consideration. For example, when the UE is involving in a computational heavy task (e.g., AI training or inference), the UE may prefer a greener network, cell, and/or frequency. This can be done by temporarily adjusting the priority of networks, cells and/or frequencies when the UE performs a computational heavy task. Then, the UE may proceed with the selection procedure for a network, a cell, and/or a frequency according to the adjusted priority.

To illustrate, an AI training application may require the UE be registered to a greener network before the application begins. A routine messaging application may not have any requirement on UE be registered on a green network before the application begins. Hence, the UE running the AI training application would consider greener network to be higher in priority. The same applies to cells and frequencies.

In a further illustration, UE using an application with high power consumption (e.g., AI inference) may prefer a network or a cell fulfilling the Eco-Rating requirement. When the UE uses that service, the UE may prefer to choose an available network or cell with Eco-Rating greater or equal to an Eco-Rating threshold (e.g., 50). That is, that network or cell has a higher priority according to the UE's priority list. The same may apply to services, network sessions and/or network slices. The UE using a high power usage service (e.g., extend reality (XR)), network session (e.g., High Speed or data rate session) or network slice (e.g. activation of network slicing) may prefer a network, cell and/or frequency which fulfills the Eco-Rating requirement.

In other words, a network, cell and/or frequency can be given a first priority if Eco-Rating of the network, cell and/or frequency fulfills the Eco-Rating requirement. The network, cell and/or frequency can be given a second priority if the Eco-Rating of the network, cell and/or frequency does not fulfill the Eco-Rating requirement. The first priority is higher than the second priority.

It should be noted that although not explicitly mentioned, the priorities of the networks or cells are time dependent and location dependent. In other words, the Eco-Rating requirement can be valid only during a specific time interval or within a specific location area.

Also, the Eco-Rating requirements can be specified for a single service or a group of services, a single application or a group of applications, a single session or a group of sessions, and a single slice or a group of slices.

The described method provides flexibility in defining Eco-Rating requirements based on specific services, applications, network sessions, or network slices. It also contributes to a more sustainable mobile network ecosystem while empowering users with environmentally conscious connection choices.

### Carbon-Intelligent Quality-of-Service Mechanism

Quality of Service (QoS) refers to the ability of a network to provide different levels of service to different types of traffic or applications. QoS helps ensure that network resources are allocated efficiently and that time-sensitive or mission-critical applications receive the required level of service, even during periods of high network congestion.

The 5G QoS model is a comprehensive framework designed to support diverse services and applications with varying QoS requirements. The 5G QoS model is based on QoS Flows. In the context of 5G networks, a QoS flow is the fundamental unit used to define and apply quality-of-service for user plane traffic. It acts as a virtual “pipe” within a PDU session, carrying specific types of traffic with defined quality requirements.

The key components of the 5G QoS model include: 5G QoS Flow Identifiers (5QI), QoS Profile, QoS flow binding and mapping, policy control, prioritization, dynamic management and network slicing integration. The 5G QoS model supports both QoS Flows that require guaranteed bit flow rate (GBR QoS Flows) and QoS Flows that do not require guaranteed flow bit rate (Non-GBR QoS Flows).

The 5G QoS model also supports Reflective QoS. A QoS Flow may either be “GBR” or “Non-GBR” depending on its QoS profile. The QoS profile of a QoS Flow is sent to the RAN and it contains QoS parameters including 5G QoS Identifier (5QI) and Allocation and Retention Priority (ARP). For each Non-GBR QoS Flow only, the QoS parameter may also include the Reflective QoS Attribute (RQA).

For each GBR QoS Flow only, the QoS parameters also includes the QoS parameters Guaranteed Flow Bit Rate (GFBR) for UL and DL, and Maximum Flow Bit Rate (MFBR) for UL and DL.

A QoS Profile is a collection of QoS parameters and characteristics associated with a specific 5QI value. It defines the QoS requirements and treatments for a particular QoS Flow or service. It typically defines settings for priority queuing, bandwidth management and traffic shaping. Priority queuing classifies data into different categories (e.g., high priority, low priority) and ensures that higher priority traffic gets processed first. Bandwidth management allocates specific bandwidth limits for different traffic types, preventing any single type from consuming excessive resources and impacting others. Traffic shaping regulates and smooth out the flow of data to avoid bursts or congestion, leading to a more stable and consistent network performance. The QoS Profile includes parameters like resource type (Guaranteed Bit Rate or Non-Guaranteed Bit Rate), Priority Level, Packet Delay Budget (PDB), Packet Error Rate (PER), and Maximum Data Burst Volume.

An Alternative QoS Profile (AQP) also represents a combination of QoS parameters (i.e., Packet Delay Budget (PDB), Packet Error Rate (PER), UL and DL Guaranteed Flow Bit Rate (GFBR)) to which the application traffic is able to adapt.

Session Management Function (SMF) provides a prioritized list of AQPs to the NG-RAN. When the NG-RAN sends a notification to the SMF that the QoS profile is not fulfilled, the NG-RAN should, if the currently fulfilled values match an AQP, include also the reference to the AQP to indicate the QoS that the NG-RAN currently fulfills.

When an NG-RAN node supports the Alternative QoS feature but cannot fulfill even the least preferred Alternative QoS Profile, it should release the QoS flow. Note that to reduce the risk that GBR QoS Flows are released in case of RAN resource limitations (and then experience difficulties in being reestablished), Application Functions (AF) can set the least preferred Alternative Service Requirement to an undemanding level.

Building on the existing QoS Profile (QP), this disclosure introduces the concept of Green QoS Profile (GQP). A QoS Profile can be incorporated with Eco-Rating. For example, a QoS Profile may include a set of existing QoS parameters (e.g., PDB, PER, GFBR UL, GFBR DL, Maximum bit rate UL, Maximum bit rate DL) plus the Eco-Rating. A Green QoS Profile is a QoS Profile with comparatively higher Eco-Rating.

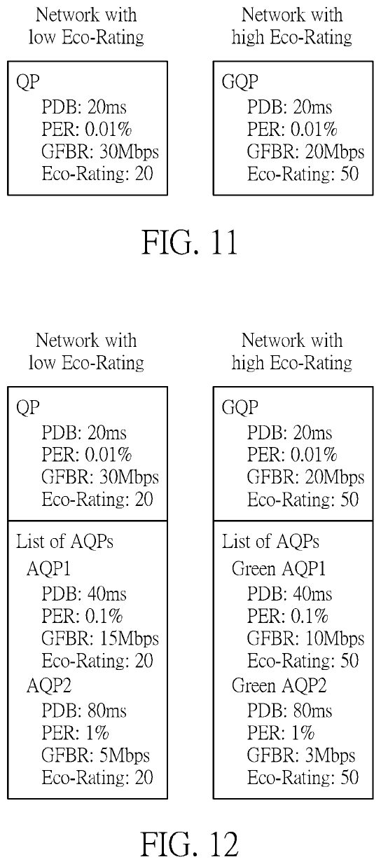

FIG. 11 illustrates an embodiment of carbon-intelligent QoS mechanism incorporated with Eco-Rating. In this embodiment, the QP (network with low Eco-Rating) has the following QoS parameters-PDB: 20 ms, PER: 0.01%, GFBR: 30 Mbps and Eco-Rating: 20; the GQP (network with high Eco-Rating) has the following QoS parameters-PDB: 20 ms, PER: 0.01%, GFBR: 20 Mbps and Eco-Rating: 50. (Note that the Eco-Rating of GQP is higher than that of QP, but the GFBR of GQP is lower than that of QP) In addition, both the QP and the GQP may be considered as providing the same level of service (e.g., the same customer satisfaction or quality of experience (QoE)) by the network, UE, or user. When the above described condition occurs, GQP may be implemented due to it being more eco-friendly.

FIG. 12 illustrates another embodiment of carbon-intelligent QoS mechanism incorporated with Eco-Rating. In addition to QP, this embodiment includes a list of AQPs. For example, AQP1 (network with low Eco-Rating) has the following QoS parameters PDB: 40 ms, PER: 0.1%, GFBR: 15 Mbps and Eco-Rating: 20; the Green AQP1 (network with high Eco-Rating) has the following QoS parameters PDB: 40 ms, PER: 0.1%, GFBR: 10 Mbps and Eco-Rating: 50. Similarly, when the corresponding AQP and Green AQP are considered as providing the same level of service (e.g., the same customer satisfaction or quality of experience (QoE)) by the network, UE, or user, Green AQPs may be implemented due to they being more eco-friendly.

In other words, there can be two lists of QoS profiles. A first list of QoS profiles is associated with a first Eco-Rating, and a second list of QoS profiles is associated with a second Eco-Rating. The second Eco-Rating is higher than the first Eco-Rating. The first list of QPs includes a first QP and AQPs, and the second list of QPs includes a second QP and AQPs (which are greener than the first list of QPs). The UE or the network can identify the application and/or service which UE is utilizing. Then it can determine whether the UE should implement the first QP or the second QP according to the first Eco-Rating, the second Eco-Rating and the application and/or service. If performance of the UE using the application and/or service with the second QP satisfies the performance requirement and the second Eco-Rating satisfies an Eco-Rating requirement, then the second QP can be implemented. If performance of the UE performing the application and/or service with the first QP satisfies the performance requirement and the first Eco-Rating satisfies an Eco-Rating requirement, but the second QP fails to satisfy the performance requirement, then the first QP can be implemented.

### Illustrative Examples

The carbon-intelligent QoS mechanism can be further illustrated by the following example.

Suppose a user watches videos during commuting and receives 5G service from the mobile network operator A. The 5GS operated by operator A is powered by both of renewable energy (e.g., solar energy) and non-renewable energy (e.g., coal). The ratio of renewable energy used by the 5GS can be calculated and obtained in a given time unit. The operator A offers a “green communication service option”, in which the service has alternative QoS profiles that takes in the consideration of the ratio of renewable energy and the subscriber's preferences, e.g., operator can provide a service with a list of two alternative QoS profiles:
Traditional QoS Profile: Packet Delay Budget is 300 ms (and lowest ratio of renewable energy is 0%, i.e., 5GS has no guarantee of using any renewable energy when providing service to this subscriber);
Alternative QoS Profile: Packet Delay Budget is 400 ms and lowest ratio of renewable energy is 40%.

The operator A can monitor the supply of renewables for its 5G system and adjust the communication services based on the supply of renewable energy.

The user, being an environmental conscious person, subscribes to the optional “green subscription” with the alternative QoS profiles. Therefore, the operator A can determine to provide a service with a higher latency but greener network function entities (e.g., a large scale computing/communication center located at a distance but powered by more than 80% renewable energy) to the user.

It should be noted that the above described green subscription ensures that QoS level criteria continue to be met (i.e., there is no trade-off between energy efficiency and QoE) since all the QoS levels in the profiles subscribed fulfills minimum service quality.

In another example, suppose a user watches videos during commuting and receives 5G service from the mobile network operator A. The user subscribes to the green subscription provided by operator A with the following list of alternative QoS profiles:
Alternative QoS Profile 1: Packet Delay Budget is 400 ms; Guaranteed bit rate is 10 Mbps and lowest ratio of renewable energy is 40%;
Alternative QoS Profile 2: Packet Delay Budget is 350 ms; Guaranteed bit rate of 15 Mbps and lowest ratio of renewable energy is 30%;
Alternative QoS Profile 3: Packet Delay Budget is 300 ms; Guaranteed bit rate of 20 Mbps and lowest ratio of renewable energy is 20%;
Alternative QoS Profile 4: Packet Delay Budget is 250 ms; Guaranteed bit rate of 25 Mbps and lowest ratio of renewable energy is 10%;
Alternative QoS Profile 5: Packet Delay Budget is 200 ms; Guaranteed bit rate of 30 Mbps and lowest ratio of renewable energy is 0%.

In other words, the user is satisfied with all the QoS profiles listed above when watching videos.

The operator A can monitor the supply of renewables for its 5G system and adjust the communication services based on the supply of renewable energy. During the daytime, the QoS level specified by Profile 1 can be fulfilled since there is enough supply of solar power to a remote computing/communication center; thus, the user can receive video streaming with bit rate of 10 Mbps, and the service uses 40% ratio of renewable energy. In the evening, the supply of solar power decreases; thus, the user receives video streaming with the QoS level of Alternative QoS Profile 2, 3, 4 or 5.

By using the “green subscription” provided by operator A, the service requested by the user may use as much renewable energy as possible and still be satisfied with the quality of video streaming.

Other benefits include reducing energy consumption in mobile networks by prioritizing connections with lower environmental impact, enabling users to make environmentally conscious choices when selecting network connections, and providing flexibility in defining Eco-Rating requirements based on specific services, applications, network sessions, or slices. The above described solution also seeks a balance between ensuring reliable network performance through optimal signal quality and promoting eco-friendly practices, making them viable solutions for network operators seeking to minimize their environmental impact while maintaining high-quality service.

### Carbon-Intelligent Access Control

The access control mechanisms in the current 5G system rely heavily on the access identity and the mapped access category to make decisions about granting or denying access to the network, as well as applying appropriate prioritization and resource allocation policies.

An access identity is a unique identifier assigned to a specific type of user equipment (UE) or service. It is used to determine the access control policies and procedures that should be applied to that particular UE or service. Some of the access identities include:
Emergency services: Used for emergency services like calls to emergency numbers;
Voice services: Used for voice calls and other voice-related services;
Data services: Used for regular data services like web browsing, messaging, etc.;
Multimedia services: Used for multimedia services like video streaming, online gaming, etc.

The following Table 2 shows some access identities defined by the 3GPP.

TABLE 2

| Access Identity number | UE configuration |
|---|---|
| 0 | UE is not configured with any parameters from this Table |
| 1 | UE is configured for multimedia priority service (MPS). |
| 2 | UE is configured for mission critical service (MCS). |
| 3 | UE for which a disaster condition applies |
| 4-10 | Reserved for future use |

An access category is a classification of the level of priority and access control rules that should be applied to a specific type of service or UE. It is directly mapped to the access identity provided by the UE during the Radio Resource Control (RRC) establishment process. Some of the access categories include:

The mapping between access identities and access categories is defined in the 5G specifications and is used by the network to determine the appropriate access control and prioritization mechanisms for each UE or service.

For example, a UE initiating an emergency call would provide the emergency services access identity during the RRC establishment process. This access identity would be mapped to the highest access category, ensuring that the emergency call is given the highest priority and access to network resources, even during congestion or overload situations.

Similarly, a UE requesting regular data services would provide the data services access identity, which would be mapped to a lower access category, allowing the network to prioritize more critical services like voice or emergency calls over regular data traffic.

The following Table 3 shows a mapping table (defined by the 3GPP) for access identities/access categories and RRC establishment cause when establishing NAS signaling connection via NR connected to 5GCN.

TABLE 3

| | | | RRC establishment cause |
|---|---|---|---|
| Rule # | Access identities | Access categories | is set to |
| 1 | 1 | Any category | mps-PriorityAccess |
| 2 | 2 | Any category | mcs-PriorityAccess |
| 3 | 11, 15 | Any category | highPriorityAccess |
| 4 | 12, 13, 14 | Any category | highPriorityAccess |
| 5 | 0 | 0 (=MT_acc) | mt-Access |
| | | 1 (=delay tolerant) | Not applicable (NOTE 1) |
| | | 2 (=emergency) | emergency |
| | | 3 (=MO_sig) | mo-Signalling |
| | | 4 (=MO MMTel voice) | mo-VoiceCall |
| | | 5 (=MO MMTel video) | mo-VideoCall |
| | | 6 (=MO SMS and | mo-SMS |
| | | SMSoIP) | |
| | | 7 (=MO_data) | mo-Data |
| | | 9 (=MO IMS registration | mo-Data |
| | | related signalling) | |

Building on the current access control mechanism, the concept of “greenness” can also be applied to access control in the 3GPP network system. A new access category and/or access identity related to Eco-Rating can be introduced. For example, UE with green battery and/or green subscription (i.e., higher Eco-Rating) can be given a new access identity and/or new access category. The UE with green battery and the UE with green subscription can be referred to as “green UE.”

The new access identity and/or access category can be configured in a USIM. The new access identity and/or access category configured in the USIM can have higher priority than the access identity and/or access category configured dynamically via NAS signaling messages.

In one illustration, UE with green battery (e.g., charged from renewable energy source) can be given a higher access category than UE with grayer battery (e.g., charged from non-renewable energy source). UE with green subscription can be given a higher access category than UE without green subscription. On the other hand, UE running a computational heavy task can be given a lower access category than UE not running a computational heavy task.

In a further illustration, the UE with gray battery may be given access category 4 for voice call while the UE with green battery may be given access category 3 for the same service. The UE without green subscription may be given access category 7 for IMS call while the UE with green subscription may be given access category 6 for the same service.

In another illustration, the green UE can be given the new access identity and/or access category configured in the SIM or USIM, which has higher priority than the access identity and/or access category configured dynamically via NAS signaling messages.

In addition, the green UE with green battery may be given a lower BarringFactor (e.g., 0 to 0.2) and/or lower BarringTime (e.g., 0 to 4 seconds) according to the access identity and/or access category.

The BarringFactor and BarringTime are broadcasted to the UE via System Information Broadcasts (SIBs) dedicated signaling messages. The UE then apply the BarringFactor and BarringTime to determine whether they should proceed with a particular procedure or back off and retry after a certain time interval elapsed. These parameters are used by the network operators to manage network congestion and prioritize access for certain services or user groups. By adjusting the BarringFactor and BarringTime, the network can control the number of UE that are allowed to access the network simultaneously, preventing overload situations and ensuring efficient resource utilization.

Note that the BarringFactor is a value between 0 and 1 that determines the probability of a UE being allowed to perform a specific procedure, such as registration, service request, or mobility management. In other words, a lower BarringFactor value means a higher probability of being allowed to perform the procedure.

Also note that BarringTime is a duration during which a UE is barred from reattempting a procedure after being barred initially. This prevents the UE from repeatedly trying the same procedure, which could further overload the network.

In some embodiments, the UE can determines the what percentage of its battery is charged from a renewable energy source. If that percentage is greater than or equal to a threshold, the UE can be considered a green UE or a UE with green battery (i.e., UE having Eco-Rating).

In some embodiments, the UE can determine whether its wireless service subscription is a green subscription by, for example, receiving a green subscription indicator from NAS signaling messages or other signaling types.

In some embodiments, the UE can identify one or more applications, services, network session, and/or network slices associated with its access attempt, so as to regulate access control policy access accordingly, e.g., access identity, access category, BarringFactor, BarringTime, etc.

It should be noted that the determination of the UE is only valid when the UE is registered to its HPLMN or its EHPLMN (if the EHPLMN list is present), and during a specific time interval and/or in a specific location area.

The presently disclosed carbon-intelligent solutions are designed to achieve optimization of carbon emissions and the overall carbon footprint. Through the implementation of the disclosed methodologies and systems, a reduction in the generation of atmospheric carbon can be effectuated. This carbon emission minimization serves the critical purpose of mitigating the environmental impact associated with such emissions, thereby contributing to the establishment of a more sustainable planet from an ecological perspective. Moreover, the diminished carbon output facilitated by the disclosed solutions yields the ancillary benefit of potentially reducing the financial burden imposed by carbon taxation regimes. Thus, the disclosed solutions simultaneously address both the environmental aspect of reducing atmospheric carbon accumulation and the economic consideration of alleviating carbon tax liabilities, synergistically promoting a dual objective of ecological preservation and fiscal prudence.

### Additional Notes

User equipment (UE) as described in this disclosure may include a device with radio communication capabilities. For example, the UE may include a smartphone (e.g., handheld touchscreen mobile computing devices connectable to one or more cellular networks). The UE may also include any mobile or non-mobile computing device, such as Personal Data Assistants (PDAs), pagers, laptop computers, desktop computers, wireless handsets, or any computing device that has a wireless communications interface.

The UE may also be referred to as a client, mobile device, mobile terminal, user terminal, mobile unit, mobile station, mobile user, subscriber, user, remote station, access agent, user agent, receiver, radio equipment, reconfigurable radio equipment, or reconfigurable mobile device. The UE may include IoT UE, which can include a network access layer designed for low-power IoT applications utilizing short-lived UE connections. IoT UE can utilize technologies (e.g., M2M, MTC, or mMTC technology) for exchanging data with an MTC server or device via a PLMN, other UEs using ProSe or D2D communications, sensor networks, or IoT networks. The M2M or MTC exchange of data may be a machine-initiated exchange of data. An IoT network describes interconnecting IoT UE, which may include uniquely identifiable embedded computing devices (within the Internet infrastructure). The IoT UE may execute background applications (e.g., keep-alive messages, status updates, etc.) to facilitate the connections of the IoT network.

Furthermore, the UE may be configured to connect or communicatively couple with the Radio Access Network (RAN) through a radio interface, which may be a physical communication interface or layer configured to operate with cellular communication protocols such as a GSM protocol, a CDMA network protocol, a Push-to-Talk (PTT) protocol, a PTT over Cellular (POC) protocol, a UMTS protocol, a 3GPP LTE protocol, a 5G protocol, a NR protocol, and the like. For example, the UE and the RAN may use a Uu interface (e.g., an LTE-Uu interface) to exchange control plane data via a protocol stack comprising a PHY layer, an MAC layer, an RLC layer, a PDCP layer, and an RRC layer. A DL transmission may be from the RAN to the UE and a UL transmission may be from the UE to the RAN. The UE may further use a sidelink to communicate directly with another UE (not shown) for D2D, P2P, and/or ProSe communication. For example, a ProSe interface may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wire or wireless means) information signals (whether containing voice information or non-voice data/control information) to/from the second entity regardless of the type (analog or digital) of those signals. It is further noted that various figures (including component diagrams) shown and discussed herein are for illustrative purpose only, and are not drawn to scale.

The various illustrative logical blocks, modules, functions, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In some embodiments, the computing instructions may be carried out by an operating system, for example, Microsoft Windows™, Apple Mac OS/X or iOS operating systems, some variety of the Linux operating system, Google Android™ operating system, or the like.

In some embodiments, the computers may be on a distributed computing network, such as one having any number of clients and/or servers. Each client may run software for implementing client-side portions of the embodiments. In addition, any number of servers may be provided for handling requests received from one or more clients. Clients and servers may communicate with one another via one or more electronic networks, which may be in various embodiments such as the Internet, a wide area network, a mobile telephone network, a wireless network (e.g., Wi-Fi, 5G, and so forth), or a local area network. Networks may be implemented using any known network protocols.

Reference has been made in detail to implementations, examples of which are illustrated in the accompanying drawings. In the detailed description above, numerous specific details have been set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

For situations in which the systems discussed above collect information about users, the users may be provided with an opportunity to opt in/out of programs or features that may collect personal information (e.g., information about a user's preferences or usage of a smart device). In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

While some embodiments comprise the disclosed features and may therefore include additional features not specifically described, other embodiments may be essentially free of or completely free of non-disclosed elements. That is, non-disclosed elements may optionally be essentially omitted or completely omitted.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of access control for user equipment (UE), comprising:
providing one or more access identities and/or access categories;
determining an Eco-Rating of the UE;
determining an access identity and/or access category of the plurality of access identities and/or access categories for the UE according to at least the Eco-Rating.

2. The method of claim 1, wherein determining the Eco-Rating of the UE comprises determining a percentage of a battery of the UE being from a renewable energy source.

3. The method of claim 1, wherein determining the Eco-Rating of the UE comprises determining an Eco-Rating based on an indicator/scalar stored in the USIM.

4. The method of claim 1, wherein determining the access identity and/or access category for the UE according to at least the Eco-Rating comprises determining the access identity and/or access category for the UE according to the Eco-Rating and at least one usage.

5. The method of claim 4, wherein the at least one usage comprises at least one application, at least one network session and/or at least one network slice.

6. The method of claim 1, wherein the plurality of access identities and/or access categories are provided via Non-access stratum (NAS) signaling messages, Subscriber Identity Module (SIM) and/or an UMTS Subscriber Identity Module (USIM).

7. The method of claim 6, wherein the plurality of access identities and/or access categories provided via the USIM have a higher priority than the access identities and/or access categories provided via the NAS signaling messages.

8. The method of claim 1, wherein determining the access identity and/or access category for the UE according to at least the Eco-Rating comprises if the Eco-Rating is above a threshold, determining the access identity and/or access category.

9. The method of claim 1, wherein the access identity and/or access category is valid for a specific time interval and/or a specific location area.

10. The method of claim 1, wherein the Eco-Rating is associated with time validity information and/or location validity information.

11. A method of access control for user equipment (UE), comprising:
determining an Eco-Rating of the UE;
determining a BarringFactor and/or a BarringTime for the UE according to at least the Eco-Rating.

12. The method of claim 11, wherein determining the Eco-Rating of the UE comprises determining a percentage of a battery of the UE being from a renewable energy source.

13. The method of claim 11, wherein determining the Eco-Rating of the UE comprises determining based on an indicator/scalar stored in the USIM.

14. The method of claim 11, wherein determining the BarringFactor and/or the BarringTime for the UE according to at least the Eco-Rating comprises determining the BarringFactor and/or the BarringTime for the UE according to the Eco-Rating and at least one usage.

15. The method of claim 14, wherein the at least one usage comprises at least one application, at least one network session and/or at least one network slice.

16. The method of claim 11, wherein determining the BarringFactor and/or the BarringTime for the UE according to at least the Eco-Rating comprises if the Eco-Rating is above a threshold.

17. The method of claim 11, wherein the BarringFactor and/or BarringTime is valid for a specific time interval and/or a specific location area.

18. The method of claim 11, wherein the Eco-Rating is associated with time validity information and/or location validity information.

19. A user equipment (UE) comprising:
a memory for storing a list of plurality of access identities and/or access categories; and
a processor coupled to the memory, configured to:
determine an Eco-Rating of the UE;
determine an access identity and/or access category of the plurality of access identities and/or access categories for the UE according to at least the Eco-Rating; and
configure the UE with the determined access identity and/or access category.

20. A user equipment (UE) comprising:
a memory; and
a processor coupled to the memory, configured to:
determine an Eco-Rating of the UE;
determine a BarringFactor and/or a BarringTime for the UE according to at least the Eco-Rating; and
configure the UE with the BarringFactor and/or the BarringTime.
